(19) United States
(12) Patent Application Publication
(10) Pub. No.: US 2026/0140485 A1
(43) Pub. Date: May 21, 2026

(54) Interface Component and Network

(71) Applicants: Fraunhofer-Gesellschaft zur Förderung der angewandten Forschung e.V., München (DE); Friedrich-Alexander-Universitaet Erlangen-Nuernberg, Erlangen (DE)

(72) Inventors: Christopher SYBEN-LEISNER, Erlangen (DE); Johannes EMMERT, Erlangen (DE); Andreas MAIER, Erlangen (DE); Richard SCHIELEIN, Erlangen (DE); Ronald MENDEZ, Erlangen (DE); Houman MIRZAALIAN DASTJERDI, Erlangen (DE)

(73) Assignees: Fraunhofer-Gesellschaft zur Förderung der angewandten Forschung e.V., München (DE); Friedrich-Alexander-Universitaet Erlangen-Nuernberg, Erlangen (DE)

(21) Appl. No.: 19/445,665

(22) Filed: Jan. 12, 2026

Related U.S. Application Data
(63) Continuation of application No. PCT/EP2024/069528, filed on Jul. 10, 2024.

(30) Foreign Application Priority Data
Jul. 12, 2023 (DE) 102023206632.7

(51) Int. Cl. G05B 13/04; G06F 18/25; G06N 5/04

(52) U.S. Cl. CPC G05B 13/041; G06F 18/25; G06N 5/04

(57) ABSTRACT

Interface component of a distributed component of a network, wherein the network comprises several distributed components with one interface component each, wherein the interface component comprises: a processor configured to determine a state of a decentralized process model associated with the respective distributed component; a communication interface configured to exchange external data for the process model associated with another distributed component of the several distributed components; an internal interface configured to receive component parameters for the process model associated with the distributed component; wherein the state is determined on the basis of the component parameters and/or the incoming external data.

### CROSS-REFERENCE TO RELATED APPLICATIONS

This application is a continuation of copending International Application No. PCT/EP 2024/069528, filed Jul. 10, 2024, which is incorporated herein by reference in its entirety, and additionally claims priority from German Application No. 102023206632.7, filed Jul. 12, 2023, which is also incorporated herein by reference in its entirety.

Embodiments of the present invention relate to an interface component and a network comprising several distributed components having one interface component each. Further embodiments relate to a production plant or material sorting plant. Another embodiment relates to a method and a corresponding computer program.

### BACKGROUND OF THE INVENTION

In general, the invention lies in the field of distributed systems for optimizing physical process chains across processes, in particular processes across companies and industry boundaries.

Process chains in industry include many process steps in a complex network that spans company boundaries. Each process step has many setting options that influence the result in terms of quality/quantity, energy costs, and CO₂ emissions. Optimizing this system according to local (e.g., profit) or global cost functions (e.g., CO₂ emissions) is desirable, but if this were done centrally, all participants would have to reveal their business secrets. therefore, there is a need for an improved approach.

### SUMMARY

An embodiment may have a network comprising several distributed components with one interface component each, wherein the several distributed components form a process chain, and wherein the interface component may have: a processor configured to determine a state of a decentralized process model associated with the respective distributed component, wherein the state together with the decentralized process model forms a digital twin of the respective component; a communication interface configured to exchange external data for the process model associated with another distributed component of the several distributed components; an internal interface configured to receive sensor data or process data as component parameters for the process model associated with the distributed component; wherein several decentralized process models together map the higher-level process chain; wherein the processor is configured as part of the network by means of the component parameters, the process model and the communication with digital twins of other components for decentralized data fusion in order to effect a state estimation of the digital twin of the component.

Another embodiment may have a production plant or material sorting plant comprising an inventive network.

According to another embodiment, a method for monitoring the state of at least one distributed component with an interface component in a network comprising several distributed components with one interface component each, wherein the several distributed components form a process chain, may have the following steps performed by a processor of the interface component: determining a state of a decentralized process model associated with the respective distributed component, wherein the state together with the decentralized process model forms a digital twin of the respective distributed component and wherein several decentralized process models together map the higher-level process chain; exchanging external data for the process model associated with another distributed component; obtaining sensor data or process data as component parameters for the process model associated with the distributed component; decentralized data fusion by means of the component parameters, the process model and the communication with digital twins of other components in order to effect a state estimation of the digital twin of the component.

Another embodiment may have a non-transitory digital storage medium having a computer program stored thereon to perform the inventive method for monitoring the state of at least one distributed component with an interface component in a network when said computer program is run by a processor of an interface component in a network comprising several distributed components with one interface component each, wherein the several distributed components form a process chain.

Embodiments of the present invention provide an interface component of a distributed component of a network. The distributed component can be, for example, a plant in a process chain, e.g., a sorting plant or a production plant. The network includes several distributed components, each having one interface component. The several distributed components form, for example, the components of the process chain. Each interface component comprises a processor, a communication interface and an internal interface. The processor is configured to determine a state of a decentralized process model associated with the respective distributed component. The communication interface is configured to exchange external data for the process model associated with another distributed component of the several distributed components. For example, the exchange can take place with further interface components associated with the further distributed components. The internal interface is configured to receive component parameters, such as sensor parameters for the process model associated with the distributed component. The state is determined on the basis of the component parameters and/or the incoming external data.

According to an embodiment, each decentralized process model comprises a state that is differentiable with respect to all component parameters and/or all incoming external data. According to embodiments, differentiable means that derivatives of the state according to component parameters, the model, and communication with adjacent process models are available. According to further embodiments, the state of the respective component together with the decentralized process model forms a digital twin of the component. If, according to embodiments, it is assumed that a decentralized process model including state is also provided in the respective interface components of the other distributed components or adjacent distributed components, then-in other words-each or at least some interface components associated with the distributed components or adjacent components can comprise a digital twin. The adjacent digital twins communicate via the communication interface.

Embodiments of the present invention are based on the realization that the use of interface components for distributed components of a system enables machine learning across the process chain and thus also global optimization can be obtained if the distributed components in a process chain are extended by corresponding interface components. The interface component allows the setting options and different qualities and quantities to be mapped for each process step. Higher-level parameters, such as energy costs or CO₂ emissions, can also be mapped for each process step in a differentiable manner, i.e., in relation to the incoming data, i.e., the parameters from the adjacent distributed components and to the internal process data. According to embodiments, the communication interface is configured to obtain a higher-level parameter and/or a cost function associated with the higher-level parameter, such as a CO₂ target, and to perform the optimization. According to embodiments, the optimization is based on component parameters and/or incoming external data (information regarding adjacent components and/or higher-level targets).

By using the interface component, it is possible for each distributed component that is coupled to the interface component to maintain a decentralized process model, which together with the respective state represents a digital twin of the component, and to use the same for modeling and optimization. The fact that the interface components exchange data (referred to above as external data) via the communication interface across processes, companies, and industries in a process chain takes into account the dependency of the distributed component-modeled as a digital twin of the distributed component.

The interface component for the distributed component of a system thus enables machine learning and, as a result, an optimizable overall system without all participants having to reveal their business secrets.

According to embodiments, only or partially or advantageously gradients of component parameters and/or derivatives of component parameters and/or a corresponding cost function are exchanged as external data during optimization. This has the advantage that it is not necessary to completely transmit the parameter relevant for a distributed component, as by exchanging the gradients merely the change in this regard is sufficient. Alternatively, a cost function, such as a global cost function, can also be transmitted in order to map an optimization target for one or more distributed components. According to embodiments, the component parameters and/or process parameters are propagated back as outgoing external data. According to embodiments, this can be the absolute value or also a gradient or a derivative.

According to further embodiments, absolute values are transmitted in addition to gradients during state determination, wherein both gradients and absolute values include quantities that actually describe the material/energy/CO2 flow between the components of the distributed system. No internal information (internal state of the component, previous process steps, etc.) is exchanged.

According to embodiments, the processor of each interface component is configured to perform decentralized machine learning/optimization, e.g., taking into account the cost function explained above. The fact that, according to embodiments, the interface components are linked along the process flow/real material flow enables optimization of the overall system using the respective digital twins. In other words, in order to implement such a machine learning system for real material flows, the components of the overall system are each mapped as digital twin and optimized in a decentralized manner. The digital twin consists of a differentiable process model in an associated state. The state of the respective digital twin is (continuously) estimated and updated in a decentralized manner on the basis of component parameters, such as sensor data, and through communication with adjacent components.

According to embodiments, the processor is thus configured to perform local optimization with regard to the distributed component or part of the global optimization with regard to the overall system. According to further embodiments, the processor is configured to determine an optimization step size for optimizing the decentralized process model on the basis of gradients and/or information about an uncertainty of the gradients.

According to embodiments, the state can be derived with respect to all component parameters, communication with adjacent components, and the digital twin model. According to embodiments, a derivable state with regard to the decentralized model can mean that the decentralized model is adapted or updated according to a variant, e.g., because the situation, such as the boundary conditions, of the decentralized component has changed. A further conclusion of the derivability of the decentralized model is that there is a maintenance requirement for the distributed component. In this respect, information regarding a maintenance requirement can be determined on the basis of the derivability with regard to the decentralized model. According to embodiments, this determination is performed by the processor. The background to this is that, by using the current component parameters and external data, it can be determined that the present process model is no longer suitable and that there is a mismatch between the distributed component and the digital twin. This mismatch can be resolved either by updating the decentralized model, i.e., the digital twin, or by returning the distributed component to its modeled state, e.g., through maintenance.

According to further embodiments, the decentralized model can be derived with regard to incoming external data. This means that, according to embodiments, it is possible to recognize which external variable has which influence on the decentralized model and, in particular, on the state of the component. In this respect, according to embodiments, the processor is configured to provide a derivative of the state on the basis of the component parameters and/or the incoming external data and/or the process model. According to embodiments, the processor uses inferential statistics, such as Bayesian methods, to determine the state.

It should be noted at this point that the interface components of the network are linked according to the material flow between several distributed components and the distributed component. This means that, according to the embodiments, the state is determined on the basis of incoming external data from other distributed components, taking into account the material flow between the several distributed components and the distributed component. In other words, this means that in particular the incoming external data from adjacent distributed components is taken into account.

Another embodiment provides a network comprising several distributed components, each with an interface component. The interface component is configured as explained above.

Another embodiment relates to a production plant or material sorting plant including a corresponding network.

Another embodiment provides a method comprising the following steps: determining a state of a decentralized process model associated with the respective distributed component; exchanging external data for the process model associated with another distributed component; obtaining a component parameter for the process model associated with the distributed component; wherein the state is determined on the basis of the component parameters and/or the incoming external data.

According to embodiments, the method can comprise the step of mapping a digital twin associated with the distributed components. According to a further embodiment, it would be conceivable for the method to comprise the step of optimizing the decentralized process model.

According to embodiments, the method can be computer-implemented.

### BRIEF DESCRIPTION OF THE DRAWINGS

Embodiments of the present invention will be detailed subsequently referring to the appended drawings, in which:

FIG. 1 is a schematic illustration of an interface component associated with a distributed component according to a basic embodiment; and

FIG. 2 is a schematic illustration of an exemplary application, in this case a material sorting plant with several distributed components and interface components according to embodiments.

### DETAILED DESCRIPTION OF THE INVENTION

Before embodiments of the present invention will be described with reference to the accompanying drawings, it should be noted that equal elements and structures are provided with the same reference numbers, so that the description of the same is interapplicable or interchangeable.

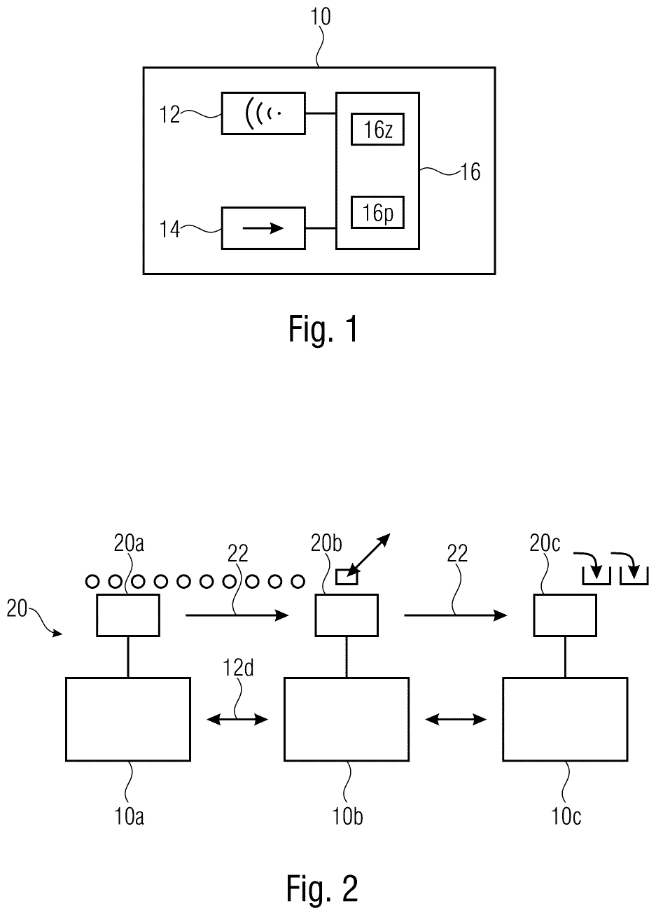

FIG. 1 shows an interface component 10 of a distributed component 20a of a network 20 of distributed components 20a-c (cf. FIG. 2). Each interface component 10 comprises the core components of a communication interface 12, an internal interface 14 and a processor 16.

As can be seen with reference to FIG. 2, the distributed components 20a-c of the network can be a production plant or a material sorting plant. A material sorting plant with a material flow 22 and three different plant components is shown here as an example. For example, the first component 20a can be a conveyor device with material analysis, the component 20b can be a material sorter, and the component 20c can be a storage medium. Each component 20a, 20b, and 20c is coupled with a separate interface component 10a, 10b and 10c, which, on the one hand, can receive component parameters or process parameters from components 20a, 20b, and 20c and, on the other hand, can communicate with the other interface components 10a/10b/10c.

For this purpose, each interface component comprises the communication interface 12 and the internal interface 14.

The internal interface 14 serves to exchange the component parameters, such as sensor data or process data 12d, with the associated distributed component 20a, 20b, and 20c. For example, via the internal interface, a sensor can be connected directly, via which data from components 20a, 20b, and 20c or control information, such as a set speed for the roller conveyor or a threshold for the sorter, can be read into interface components 10a, 10b, and 10c, respectively.

The communication interface 14 is used to exchange data with external components, i.e., with other distributed components. For example, the interface component 10b can obtain information about the material flow speed from the interface component 10a, based on which then individual process parameters for the component 20b are set. Depending on the application or current objective, this information can be obtained either as an absolute value or as a relative value in the sense of faster than before or slower than before (possibly with associated change information or gradients). For example, absolute values are exchanged during information exchange for state assessment, while relative gradients/requirements are exchanged during optimization. In both cases, the relative or absolute values refer to the same physical quantities, which in turn primarily describe the material/energy/CO2/etc. flow between the components. According to embodiments, the external data to be exchanged can include information regarding material, energy, CO2, etc. flow between the components.

The processor 16 uses a decentralized process model 16p to determine a state of the associated distributed component, i.e., component 20a for interface component 10a, component 20b for interface component 10b, or component 20c for interface component 10c. The determination is made using the so-called decentralized twin, which represents the combination of the process model 16p and the state information 16z. Since there is a dependency between components 20a, 20b, and 20c, the digital twin is adapted for the exchange of external data 12d.

The basis for implementation is the interface component 10 discussed above for the distributed components 20a, 20b, and 20c of the system 20. These interface components 10 enable machine learning for each component 10a, 10b, and 10c, and thus an optimizable system. In order to implement such a machine learning system for real material flows, the individual components 20a, 20b, and 20c of the overall system are mapped as a digital twin. This digital twin consists of a differentiable process model 16p and an associated state 16z. The state 16z of the digital twin is constantly estimated and updated in a decentralized manner on the basis of sensor data or through communication with adjacent components (=modeling for the purpose of determining the state). This state can be derived with regard to all component parameters, communication with adjacent nodes, and the digital twin model.

According to embodiments, the digital twin can be optimized in detail as follows: The interface components 10 for the distributed components 20 form the basis for optimizing any networks as a system. The derivative of a cost function is propagated backwards through the network, for example, and multiplied by the derivative of the node at each node. This calculates and executes the change steps for each process parameter. After several steps, the system approaches the optimum.

In order to transfer this approach to machines that operate on a real material flow and therefore do not implicitly have derivatives, the digital twin is used for each process step. The digital twin consists of a differentiable model and a continuous state description (real number vector) and can thus assume (provide) the derivatives, i.e., the influence of a change in the input variables or parameter variables, for each state. The state of each digital twin is estimated as accurately as possible using local sensor data, the model, and communication with other digital twins (decentralized data fusion). This takes place, for example, using inferential statistics (Bayesian inference). This estimation result (e.g., maximum a posteriori estimate) is to be differentiable with respect to all input variables (parameters, communication with other digital twins, models). This means that all models have to also be differentiable. In principle, white-box, gray-box, and black-box models can be used.

This approach has the advantage of enabling a digital twin to be generated/generatable for any component, which models the dependency on internal data (data directly related to the respective component) and external data (data indirectly related to the respective component). Typically, those external data 12d are relevant for a component 20c that are directly adjacent in terms of material flow, i.e., data from the external component 20b. These data can be determined from the digital twin of the interface component 10b, either on the basis of the component parameters of component 20b or, again, from other external data 12d. Each digital twin represents the respective component 20a, 20b, and 20c in its relevant dependency without the direct need to model the overall system. Conversely, however, the overall system is modeled by the several the interface components 10a-10c. This approach has significant advantages:
The distributed system 10a, 10b, and 10c for optimizing process chains (see reference number 20) across processes, companies, and industries allows global optimization to be achieved in that each process model 10p is optimized locally/decentrally and is linked with the adjacent interface components or all other interface components or globally and, on the other hand, the sensitivity of the individual data of the network participants is maintained, since only the relevant data 12d is exchanged or even only gradients are exchanged. Optimization in this context means setting the parameters of all processes affecting the material flow in such a way that a cost function is minimized. A characteristic of a cost function can be a social objective such as CO2 reduction, or a company-or sector-related objective, such as the reject rate or negative profit.

Decentralized optimization also has positive effects on the cross-company approach: With the help of the interface components 10a/10b/10c for distributed components 20a/20b/20c of a machine learning system, different cross-company and cross-sector process chains can be digitized and optimized. For this purpose, each process step or component 20a, 20b, 20c is provided with an interface 10a, 10b, 10c for backpropagating gradients of the cost function in order to enable optimization based on backpropagation in machine learning. Cost function as an external specification, e.g., from the legislator or another higher-level organization, means that not only process data from other components are exchanged as external data, but also complex functions that define an objective, such as maximum CO₂ emissions. This is actually only possible in the case of fully digital process steps, which is why the interface component 10 for distributed components 20 of a machine learning system was not directly applicable to physical process chains. To make this possible nonetheless, the interface component 10 now supplements each process step or component 20 with a digital twin consisting of a process model 16p and an associated state description 16z. The scope of such a digital twin can be freely selected by the responsible market participant and can encompass a single process step, machine, component, or even the entire company. The interface component 10 described above is then attached to the digital twin, enabling the backpropagation of gradients and thus the decentralized optimization of the process chain. In order to enable precisely this backpropagation, the state 16z of the digital twin is estimated as accurately as possible. This is estimated on the one hand from local sensor data (cf. interface 14), but is also based on information 12d that is exchanged between the digital twins of adjacent process steps (cf. interface 12).

According to embodiments, an extension of the interface 10 can take place in order to enable the exchange of additional information with associated uncertainty measures instead of just gradients (change in a process parameter exchanged as external data 12d).

According to embodiments, this state estimation 16z can be implemented using methods of inferential statistics (e.g., Bayesian inference, decentralized Kalman filtering, etc.). It is important that the implementation is fully differentiable, i.e., the derivatives of the state according to component parameters, the model 16p, and communication with adjacent digital twins are available. This has the following purpose:
In order to optimize the process/component parameters, the derivative with respect to the same is known.
If the machine 20 wears out, the associated model 16p can be adapted/re-trained.
Communication between adjacent digital twins represents the physical material flow. For global optimization of the process chain, the derivatives relating to the communicated information can therefore also be known. The uncertainty considerations in the communication between digital twins and in the state estimation are also crucial for the backpropagation of gradients and thus for optimization, as they can also provide information about the accuracy of the gradients. Based on these gradient uncertainties, the optimization step width can be optimally selected to avoid overshoot or similar phenomena. In addition, the validity and quality of the model 16p can be continuously checked via the uncertainties of the model 16p, the sensor data, and the communication in order to provide a cost function for retraining the model 16p or to signal needed maintenance/repair.

This results in the following advantages. The interface component in distributed components of a machine learning system can now also be applied to processes with physical material flow, so that process chains in industry that operate on physical material flows can also be optimized. These optimization methods still protect business secrets, which is made possible by the decentralized optimization method using the interface component in combination with decentralized state estimation. According to embodiments, the machine can be assessed in terms of wear or degeneration (e.g., abrasion, clogging, etc.), namely by the fact that the existing model 16p of the digital twin no longer perfectly matches the real process. Since derivatives regarding the models are detected, a model that no longer matches the real behavior of the process step can be marked as a model or component that needs to be adjusted. The consequence of a model that no longer matches is either the signaling of maintenance (generally deriving maintenance information) or retraining of the model. If, for example, a component 20b is replaced by a very similar component 20b′, this approach can be used to update the model.

According to a further embodiment, it is also possible to exchange uncertainties in the gradients of the digital twins as part of the external data 12d in order to prevent overshoots and instabilities in the optimization. Depending on the uncertainty, the step width can be adapted during optimization.

According to embodiments, an API can be used as an interface component for distributed components of a machine learning system if the API is extended to include communication options for the states of the digital twins. According to embodiments, the digital twin can be configured to provide gradient information. The gradient information is sufficient to enable decentralized data fusion for state estimation of the digital twins. In this respect, it is sufficient to exchange this gradient information as external data. According to embodiments, the processor is configured to provide differentiability of the decentralized data fusion in order to enable backpropagation of the gradients. Here, differentiability means that the influence of external information, e.g., external data in the form of backpropagated gradients or external cost functions, on the state of the digital twin can be calculated directly. As explained above, uncertainties in the gradients are detected by the continuous statistical analysis and can be taken into account during optimization in the form of adaptation of the optimization step width by the processor 16. The combination of interface component 10 for distributed components 20 of a machine learning system with a differentiable digital twin and the integration of state communication into the API represents a particular advantage. The result is a differentiable decentralized data fusion for state estimation of the digital twins. Optimization via the interface components 10 for distributed components 20 of a machine learning system can use conventional optimization algorithms and is performed locally. Decentralized data fusion is used for this purpose.

As already explained above, the main applications to date are processes that have not yet been digitized or have only been partially digitized, such as those found in production plants or material sorting plants. These plants can be extended to include the interface component 10 or several interface components 10 per component in a plant. According to embodiments, individual interface components can not only communicate within the internal network of the production plant/material sorting plant, but also exchange information externally, e.g., with upstream or downstream processes. According to embodiments, the interface components communicate in particular with the upstream and downstream interface components as seen in the material flow direction.

According to embodiments, it would also be possible that, in addition to the gradients, cost functions are provided to the individual interface components as external data (cf. 12d), as some sort of objective. The differentiable process model has the advantage of enabling optimization with regard to the cost function, e.g., by adapting process parameters. The background to this is that the processor can represent each process parameter together with its influence on another parameter, such as a cost function, in a differentiable manner. Adapting these process parameters also causes other process parameters, e.g., other components. The individual interface component that performs local adaptation with regard to the cost function can then make the respective process parameter or a gradient of the respective process parameter (derivative of the process parameter) available (backpropagate) to the other interface components as external data.

According to further embodiments, the processor of an interface component can be connected to a memory, in particular an internal memory, i.e., a memory integrated in the interface component, on which the decentralized process model is stored. The processor retrieves this process model and modifies the same or uses the same by using the external data and/or component parameters. According to embodiments, this decentralized process model enables the state of the respective distributed component to be modeled, taking into account the internal parameters and also the adjacent external parameters, e.g., from upstream or downstream units. The several decentralized process models together represent a higher-level process, which can be referred to as an overall process or as part of an overall process. The decentralized process model represents a local and decentrally stored and used process model, which, in conjunction with other decentralized process models, forms a higher-level process model. However, the corresponding model data continues to be stored decentrally. The combination of at least two interface components forms a system with a higher-level process model comprising at least two decentralized process models associated with the respective distributed components.

According to embodiments, the models are not only stored in local memories, but the state data or any sensor measurements are also stored locally. This has the advantage that only information relating to physically exchanged material or energy flows is exchanged with adjacent nodes. Thus, state detection can also be realized in the distributed system rather than via a centralized cloud.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine readable carrier.

Other embodiments comprise the computer program for performing one of the methods described herein, wherein the computer program is stored on a machine readable carrier. In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Network comprising several distributed components with one interface component each, wherein the several distributed components form a process chain, and wherein the interface component comprises:
a processor configured to determine a state of a decentralized process model associated with the respective distributed component, wherein the state together with the decentralized process model forms a digital twin of the respective component;
a communication interface configured to exchange external data for the process model associated with another distributed component of the several distributed components;
an internal interface configured to receive sensor data or process data as component parameters for the process model associated with the distributed component;
wherein several decentralized process models together map the higher-level process chain;
wherein the processor is configured as part of the network by means of the component parameters, the process model and the communication with digital twins of other components for decentralized data fusion in order to effect a state estimation of the digital twin of the component.

2. Network according to claim 1, wherein each decentralized process model comprises a state that is differentiable with respect to all component parameters and/or all incoming external data.

3. Network according to claim 1, wherein the external data comprise a gradient of component parameters and/or a derivative of component parameters and/or a cost function.

4. Network according to claim 1, wherein the communication interface is configured to propagate component parameters and/or process parameters back as outgoing external data.

5. Network according to claim 1, wherein the state is derivable with respect to the decentralized model.

6. Network according to claim 1, wherein the decentralized model is derivable with respect to incoming external data.

7. Network according to claim 6, wherein the processor is configured to provide a derivative of the state according to the component parameters and/or the incoming external data and/or the process model.

8. Network according to claim 1, wherein the processor uses inferential statistics, in particular Bayesian methods, to determine the state.

9. Network according to claim 1, wherein the processor is configured to determine, on the basis of gradients or information about an uncertainty of an optimization step width, the optimization of the decentralized process model.

10. Network according to claim 1, wherein the communication interface is configured to receive a higher-level parameter and/or a cost function associated with the higher-level parameter.

11. Network according to claim 1, wherein the component parameters comprise sensor parameters.

12. Network according to claim 7, wherein the processor is configured to detect, by using the current component parameters and external data, a deviation between the decentralized model of the distributed component and the digital twin.

13. Network according to claim 12, wherein the processor is configured to update and/or redetermine the decentralized process model when a deviation is detected; and/or to determine information regarding a maintenance requirement of the distributed component on the basis of the deviation.

14. Network according to claim 1, wherein the processor is configured to perform an optimization of the decentralized model on the basis of the component parameters and/or the incoming external data.

15. Network according to claim 1, wherein the interface component comprises an internal memory on which the decentralized process model is stored.

16. Network according to claim 1, wherein at least two interface components of the several distributed components in interaction form a higher-level process model comprising the respective decentralized process models.

17. Network according to claim 16 comprising several interface components of the network that are linked to each other according to a material flow between the several distributed components and the distributed component; and
wherein the processor is configured to determine the state on the basis of incoming external data from further distributed components taking into account a material flow between the several distributed components and the distributed components.

18. Production plant or material sorting plant comprising a network according to claim 1.

19. Method for monitoring the state of at least one distributed component with an interface component in a network comprising several distributed components with one interface component each, wherein the several distributed components form a process chain, comprising the following steps performed by a processor of the interface component:
determining a state of a decentralized process model associated with the respective distributed component, wherein the state together with the decentralized process model forms a digital twin of the respective distributed component and wherein several decentralized process models together map the higher-level process chain;
exchanging external data for the process model associated with another distributed component;
receiving sensor data or process data as component parameters for the process model associated with the distributed component;
decentralized data fusion by means of the component parameters, the process model and the communication with digital twins of other components in order to effect a state estimation of the digital twin of the component.

20. A non-transitory digital storage medium having a computer program stored thereon to perform the method for monitoring the state of at least one distributed component with an interface component in a network comprising several distributed components with one interface component each, wherein the several distributed components form a process chain, comprising the following steps performed by a processor of the interface component:
determining a state of a decentralized process model associated with the respective distributed component, wherein the state together with the decentralized process model forms a digital twin of the respective distributed component and wherein several decentralized process models together map the higher-level process chain;
exchanging external data for the process model associated with another distributed component;
receiving sensor data or process data as component parameters for the process model associated with the distributed component;
decentralized data fusion by means of the component parameters, the process model and the communication with digital twins of other components in order to effect a state estimation of the digital twin of the component,
when said computer program is run by a processor of an interface component in a network comprising several distributed components with one interface component each, wherein the several distributed components form a process chain.
